(19) United States
(12) Patent Application Publication
(10) Pub. No.: US 2017/0308994 A1
(43) Pub. Date: Oct. 26, 2017

(54) METHOD AND THERMAL IMAGING RECORDING DEVICE FOR GENERATING RADIOMETRIC IMAGES WITH ENHANCED RESOLUTION IN PARTIAL AREAS

(71) Applicant: Testo SE & Co. KGaA, Lenzkirch (DE)

(72) Inventor: Jan-Friso Evers-Senne, Titisee-Neustadt (DE)

(73) Assignee: Testo SE & Co. KGaA, Lenzkirch (DE)

(21) Appl. No.: 15/516,822

(22) PCT Filed: Oct. 6, 2015
(86) PCT No.: PCT/EP2015/001960

§ 371 Date: Apr. 4, 2017

(30) Foreign Application Priority Data
Oct. 9, 2014 (DE) 10 2014 014 737.1

(51) Int. Cl. G06T 3/40; H04N 5/33; G06T 5/00; G06T 5/20

(52) U.S. Cl. CPC G06T 3/4053; G06T 5/20; H04N 5/33; G06T 5/008; G06T 2207/10016; G06T 2207/20208; G06T 2207/10048

(57) ABSTRACT

The invention relates to a method and a thermal imaging recording device for the treatment of raw images (1a, 1b, 1c, 1d, 1e) for generating radiometric images, wherein a sequence of raw images composed of pixels are recorded in a non-visible spectral range and radiometric images are calculated on the basis of said sequence of raw images. According to the invention, high-resolution points and/or regions are calculated at least for partial regions of the radiometric images, wherein, in a first step, an edge contrast enhancement is automatically calculated for at least one raw image from the sequence and, in a second step, at least one point or region of interest of the at least one raw image which has been modified during the first step by edge contrast enhancement, is/are identified and wherein, in a third step, first radiometric values and then the image, which is highly resolved in partial areas, are automatically calculated for the at least one point or region of interest identified in the second step.

### BACKGROUND

The invention relates to a method and thermal image recording apparatus for preparing raw images for producing radiometric images, wherein a sequence of raw images composed of pixels is recorded in a nonvisible spectral range and radiometric images are calculated from this sequence of raw images, wherein an image with a high resolution at least in one portion is calculated.

Currently, the resolution of raw images (spatially resolved individual measurement results) in the nonvisible spectral range, particularly when recorded by a thermal imaging camera or an infrared-sensitive detector, preferably for the purposes of determining the temperature of at least one point or region of interest, is insufficient to depict small objects in particular, the dimension of which lies below the “instantaneous field-of-view” (iFoV) of the measurement instrument, or ascertain the correct temperature thereof on the basis of radiometric images calculated from raw images.

The term “iFoV” denotes the two-dimensional, rectangular section of an overall image covered by a single pixel of a suitable measurement instrument, for example of at least one detector of a thermal imaging camera (in particular of an infrared camera). Hence, the “iFoV” value represents a measure for the spatial resolution of the respective detector, as a result of which the dimension of the smallest possible, still detectable object is defined (depending on the distance of the object from the at least one detector used for the measurement).

An earlier patent application by the applicant (DE102011121332 A1) has already considered the problem of how it is possible to increase the resolution of such a measuring device without having to increase the resolution of the detector or the detectors of an existing measurement instrument. Increasing the resolution of existing measurement instruments, for example by retrofitting with new detectors, is always also linked to a significant cost outlay. The aforementioned earlier application described a number of methods which include the movement of a camera or of a detector in order to be able to combine a plurality of recorded individual raw images to form a super-resolution image (SR image) with a higher resolution.

Especially for recording raw images in the nonvisible spectral range, the resolutions and processor capabilities for calculating radiometric images of the existing measurement apparatuses used for recording raw images and producing raw images are still so limited that these appliances are not suitable for creating highly resolved thermal images of an object or of an area in real time.

Due to the relatively high cost outlay, it is, as a rule, uneconomical to retrofit existing measurement instruments with new technical components for measuring raw images and, optionally, for producing radiometric images from a sequence of raw images. As a consequence, radiometric values and, in particular, the ascertained temperatures of objects, the dimensions of which lie below the “iFoV” value of existing measurement instruments, cannot be determined in real time and/or cannot be determined with a sufficient resolution by the use of such appliances. What may therefore occur in the case of the measurement with current existing appliances is that only approximated temperature values are obtained, in particular for such small objects.

However, monitoring the temperature of a region or point, in particular of a moving region or point, represents a decisive metrological control in many, in particular continuously ongoing processes. Particularly in the case of many manufacturing processes which, in particular, are carried out in an automated manner, the temperature often represents an important factor for ensuring a high quality of the product produced by this manufacturing process and for avoiding damage to manufacturing installations by way of a timely identification of deviating temperatures. Therefore, what is decisive in many manufacturing processes, also for the purposes of ensuring a high product quality, is that ideal, in particular constant temperatures are present during manufacturing. Deviations from a specific temperature ideal also mean a reduced quality of the product to be produced under certain circumstances. For the aforementioned reasons, it may be important to identify deviations of the temperature from a certain target value within the shortest possible amount of time.

Currently, attempts are made to merely circumvent the aforementioned technical limitations by virtue of the distance between a measurement instrument and the object to be examined or the area to be examined being reduced and/or by virtue of use being made of measurement instruments with a multiplicity of very small detectors which, however, are also cost-intensive in production, on the basis of which it is possible to increase the resolution of the measurement results. However, the disadvantage also continues to exist here that such a multiplicity of highly resolved measurement results cannot be processed in real time due to the lack of a restricted computational power of the currently existing measurement instruments, and so, for example, it is not possible to use existing measurement instruments for real-time operation unless, for example, the processor computational power of such appliances is drastically increased as well. However, retrofitting existing appliances is often not possible at all or in turn leads to increased manufacturing costs. However, displaying radiometric images in real time is worth pursuing in many processes in order to be able to react as quickly as possible to temperature changes.

### SUMMARY

Thus, in particular, the technical objective underlying this invention is developing a method which, using existing capability-limited technical means which e.g. have a restricted computational power and/or detectors with a low resolution, nevertheless facilitates the production of radiometric images of objects or regions in real time and with a highly resolved quality.

According to the invention, this object is achieved on the basis of the features according to the invention with the aid of the method set forth at the outset. Hence, for providing the solution, provision is made according to the invention in the method described at the outset, in particular, for edge contrast enhancement to be calculated automatically for at least one raw image from the sequence in a first step, for at least one point or region of interest to be identified in a second step from the at least one raw image modified by edge contrast enhancement in the first step, and for initially radiometric values and subsequently high-resolution image data of the highly resolved image to be calculated automatically in a third step for the point or region of interest identified in the second step.

Provision may be made for the individual raw images of the sequence to be recorded in succession. Here, the respectively recorded image sections of the individual raw images may be slightly displaced relative to one another, with at least the at least one point or region of interest being contained in all raw images.

The (spatially resolved) raw images formed of radiometric raw data and being composed of pixels are preferably recorded in two dimensions. Here, it is expedient if the raw images are recorded using a suitable measurement instrument, such as e.g. a thermal imaging camera or a two-dimensionally recording, infrared-sensitive detector.

In order to be able to capture relatively small points or regions, in particular structures of interest, the dimensions of which lie below the “iFoV” value of the employed measurement instrument or detector, in an improved fashion, edge contrast enhancement for at least one raw image from a sequence of raw images composed of pixels is calculated automatically. Expedient filter methods for edge contrast enhancement may be any type of (focus) peaking method, in particular the already known methods of Laplace filtering and/or unsharp masking. By using such filter methods known per se, it is possible to highlight contours in images of at least one raw image, in particular in real time, in order therefore also to be able to identify small points or regions, in particular structures of interest, in an improved fashion, which small points or regions could otherwise possibly not be represented sufficiently well.

Provision may be made for a hottest and/or coldest point or region to be identified, preferably to be identified automatically or manually, as the at least one point or region of interest. Provision may also be made for at least one point or at least one region in a predetermined temperature range to be identified as the at least one point or region of interest. Hence, automatic identification may be carried out.

In the method according to the invention, provision may be further made for the radiometric values, from which the actual temperatures are preferably ascertained, of the at least one point or region of interest to be calculated automatically by means of a stored characteristic, in particular a characteristic based on a recursively calculated parameter. Hence, accurate temperature values are calculable from the raw data of the point or region of interest.

In contrast to the at least one point or region of interest, provision may be made in the method according to the invention for the radiometric values of all points or regions within the entire image section to be recorded, lying outside of the points or regions of interest, to be ascertained by an approximation method on the basis of raw data, for example on the basis of the interpolation of raw data from at least two raw images. Determining the radiometric values of the points or regions lying outside of the at least one point or region of interest on the basis of an approximation method is advantageous in that the computational power of a processor required to this end is lower than on the basis of a stored characteristic, in particular based on a computationally-intensive recursive function (which may be used e.g. for calculating the radiometric values of the at least one point or region of interest). By way of example, the approximation method may be able to be carried out and may be carried out using a parameterized characteristic, the parameters of which are ascertained for an interpolation method.

Such a procedure is therefore also advantageous in that the processor computational power required for the calculation of a radiometric image, carried out according to the invention, is lower when producing a radiometric image with a high resolution at least in portions than in the case of images, the total content of which is represented in a highly resolved quality. Therefore, it is possible, for example, to combine the method according to the invention with existing measurement instruments without needing to retrofit these measurement instruments with much cost outlay, for example by way of new highly resolving detectors and/or new processors, in order to be able to display highly resolved images in real time.

Therefore, for the first time, the method according to the invention facilitates being able to produce radiometric images with a high resolution at least in portions in real time using existing measurement instruments, in particular, without the need for retrofitting these appliances with much outlay.

For the purposes of calculating a radiometric image with a high resolution at least in portions, it may be necessary for a displacement vector describing an image displacement to be calculated automatically for each raw image for the purposes of calculating a highly resolved image from the sequence of raw images, in particular by virtue of the displacement vector being calculated automatically in an optical flow method.

In so doing, it is particularly expedient if the displacement vector is calculated automatically on the basis of the point or region of interest. Hence, it is possible to register image contents corresponding to the point or region of interest in the recorded sequence.

Hence, on the basis of this displacement vector, it is possible to identify the at least one previously identified point or region of interest in the further raw images to be processed which are composed of pixels.

Provision may be further made for a sufficient number of raw images to be processed in the method according to the invention, in particular in the automatic calculation of a radiometric image with a high resolution at least in portions, for example by virtue of at least 3, preferably at least 4, in particular at least 5 or more raw images, in particular displaced relative to one another in the image section, being processed for the automatic calculation of a highly resolved image. Here, a sufficient number of raw images is necessary so that it is possible to undertake a movement estimate (image displacement) between these images on the basis of a displacement vector. The movement estimate may also be calculated automatically section-by-section in relation to the sequence of raw images composed of pixels. Here, use may also be made of a dynamic adaptation in order to optimize the value range of the available raw data.

Since provision may be made for continuous processing of the raw images to be carried out for the purposes of producing real-time images, the image displacements, once determined, may be reused.

In order to determine the exact temperature of the at least one point or region of interest, provision may be made for the temperature of the at least one point or region of interest to be ascertained on the basis of at least one calculated, highly resolved image.

In the method according to the invention, provision may be made for the at least one highly resolved point or region of interest to be displayed in an image, which at least partly has lower resolution, preferably in real time. Preferably, the display takes place at the correct location in the radiometric image with a lower resolution.

Moreover, it is expedient for at least a temperature maximum and/or a temperature minimum and/or a specific temperature value and/or temperature range to be identified automatically in the highly resolved image.

Further, it may be convenient if at least a temperature maximum identified in the highly resolved image and/or a temperature minimum and/or a temperature value and/or temperature range derived from the highly resolved image is displayed, preferably displayed at the correct location, in a radiometric image with the resolution of the raw image.

For the purposes of carrying out the method according to the invention, provision may be made for the at least one point or region of interest to be identified in the raw image by segmentation.

When carrying out the method according to the invention, provision may moreover be made for in each case at least one point or region to be identified in the individual raw images of the sequence, said at least one point or region corresponding to the at least one point or region of interest of the at least one raw image. It is advantageous here that radiometric data may be calculated for these corresponding points or regions. Using these, highly resolved image data are calculable by way of known methods for the point or region of interest.

When carrying out the method according to the invention, provision may be made for the at least one identified point or region to be used for calculating the highly resolved image.

According to the invention, the mentioned object is further achieved by a thermal image recording apparatus for recording and preparing raw images for producing radiometric images, which have a high resolution in portions, said thermal image recording apparatus being characterized in that it comprises a detector configured to record raw images, an image processing device, a means for identifying at least one point or region of interest, a means for calculating radiometric data and a means for calculating a highly resolved image region.

Here, it may be expedient for the point or region of interest, for which the radiometric data are calculated, to be predeterminable and/or for the image region, for which ascertaining is carried out using an approximation method, to be predeterminable. Here, the point or region of interest may be predeterminable manually or automatically.

The thermal image recording apparatus according to the invention may further be characterized in that the thermal image recording apparatus comprises a means for converting an image position in a highly resolved image to an image position at the resolution of a raw image. Here, it is advantageous that displaying highly resolved image data may be dispensed with.

In particular, the thermal image recording apparatus according to the invention may be configured to carry out the method according to the invention, in particular as described above and/or according to a claim directed to a method.

### BRIEF DESCRIPTION OF THE DRAWINGS

The invention will now be described in more detail on the basis of an exemplary embodiment without, however, being restricted to this exemplary embodiment. Further exemplary embodiments emerge by combining individual or a plurality of features of the claims amongst themselves and/or with individual or a plurality of features of the exemplary embodiment.

In detail:

FIG. 1 shows a much simplified and schematized schematic diagram for explaining the method according to the invention.

### DETAILED DESCRIPTION OF THE PREFERRED EMBODIMENTS

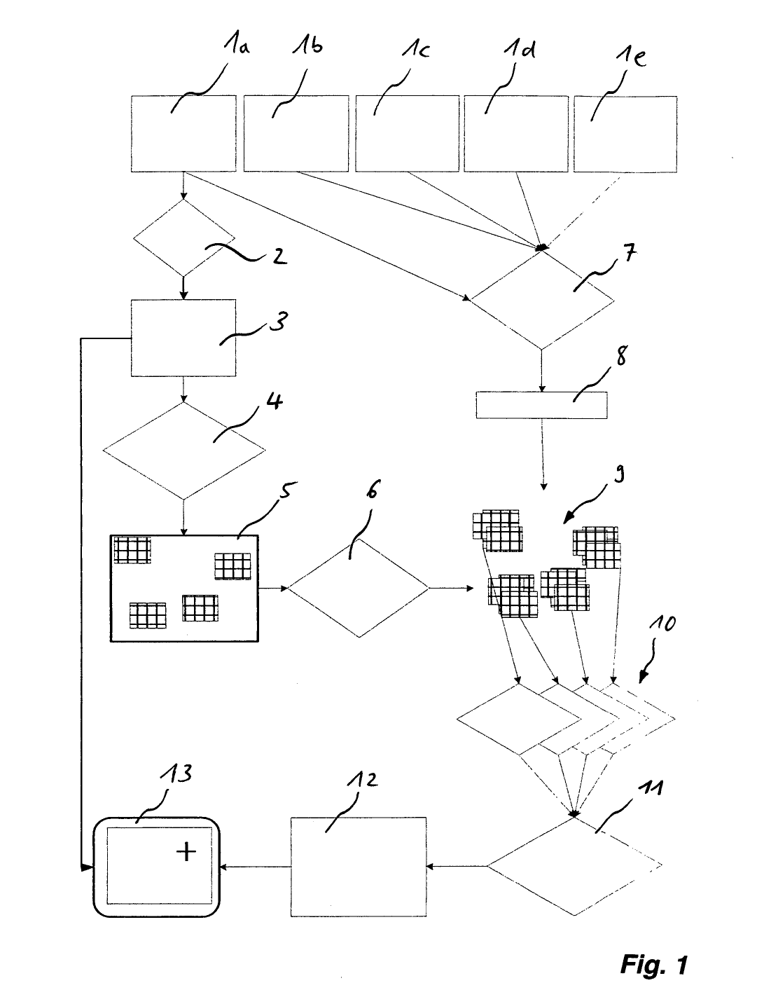

FIG. 1 shows a simplified and schematized schematic diagram of the procedure of an exemplary embodiment of the method according to the invention.

In a first step of the method according to the invention, at least one raw image 1a is selected, preferably automatically, from a sequence of two-dimensional raw images 1a, 1b, 1c, 1d, 1e composed of pixels which are recorded in a nonvisible spectral range by a suitable measurement instrument such as a thermal imaging camera or a two-dimensionally recording, infrared-sensitive detector, said at least one raw image subsequently serving as a reference and edge contrast enhancement 2, preferably by means of peaking, being calculated automatically for said at least one raw image. By way of edge contrast enhancement 2, it is possible to create a raw image with peaked edges 3 in which, in particular, small objects are identifiable in an improved fashion, which small objects could otherwise not be depicted sufficiently clearly.

Subsequently, in a second step 4 of the method according to the invention, at least one point or region 5 of interest is identified from the at least one raw image 3 modified by edge contrast enhancement in the first step. In the method shown in FIG. 1, provision is made for a hottest and/or coldest point or region, in particular at least one structure of interest, and/or a point or region in a predetermined temperature range to be identified automatically or manually as the at least one point or region 5 of interest.

Subsequently, the radiometric data of the at least one point or region 5 of interest are calculated automatically 6 by a stored characteristic. Although not depicted here, the radiometric data of all points or regions of the overall remaining, likewise to be recorded image section lying outside of the points or regions 5 of interest, in particular outside of the at least one structure of interest, are ascertained by means of an approximation method on the basis of raw data, for example on the basis of an interpolation of parameters between nodes.

For the purposes of calculating a radiometric image with a high resolution at least in portions on the basis of the method according to the invention, it is then necessary, for the purposes of calculating a highly resolved image from the sequence of the plurality of raw images, in particular raw images 1a, 1b, 1c, 1d, 1e, for a displacement vector 8 describing an image displacement to be calculated for each one of these raw images, in particular by virtue of the displacement vector 8 being calculated as depicted in FIG. 1 in an optical flow method 7. Here, it is possible for the displacement vector 8 to be calculated on the basis of the at least one point or region 5 of interest identified on the basis of the reference image 3. Thus, respectively at least one point or region may be identified in the individual raw images 1a, 1b, 1c, 1d, 1e of the sequence which corresponds to the at least one point or region 5 of interest of the at least one raw image selected as a reference.

In the method according to the invention depicted in FIG. 1, provision is made for the use of, in each case, at least three radiometric images of the identified points or regions 5 of interest, which are depicted here as two-dimensional areas 9 traversed by a grid, for calculating an image 10 with high resolution in portions.

Subsequently, the temperature of the at least one point or region 5 of interest may be ascertained on the basis of at least one calculated, highly resolved image 12. As a result, it is moreover possible to identify 11 the in fact coldest and/or hottest point or region in the recorded image section.

For the purposes of carrying out the method according to the invention as explained on the basis of the exemplary embodiment, provision may be made of using a suitable measurement instrument, preferably the thermal image recording apparatus according to the invention.

Further, provision may be made for the calculated temperature value or the temperature values of the at least one point or region 5 of interest to be displayed as a numerical value or as a plurality of numerical values, in particular on a display 13, in particular on a measurement instrument with the display 13.

Therefore, provision may further be made for the thermal image recording apparatus according to the invention to comprise a display 13 for displaying the temperature or temperatures, ascertained by means of the method according to the invention, of the at least one point or region 5 of interest.

The invention relates to a method and thermal image recording apparatus for preparing raw images 1a, 1b, 1c, 1d, 1e for producing radiometric images, wherein a sequence of raw images composed of pixels is recorded in a nonvisible spectral range and radiometric images are calculated from this sequence of raw images, wherein highly resolved points and/or regions are calculated at least for portions of the radiometric images by virtue of edge contrast enhancement being calculated automatically for at least one raw image from the sequence in a first step, at least one point or region of interest being identified in a second step from the at least one raw image modified by edge contrast enhancement in the first step, and initially radiometric values and subsequently the image with a high resolution in portions being calculated automatically in a third step for the at least one point or region of interest in the second step.

1. A method for preparing raw images for producing radiometric images, comprising recording a sequence of raw images composed of pixels in a nonvisible spectral range and calculating radiometric images from said sequence of raw images, wherein an image with a high resolution at least in one portion is calculated, automatically calculating edge contrast enhancement for at least one of the raw images from the sequence in a first step, identifying at least one point or region of interest in a second step from the at least one raw image modified by the edge contrast enhancement in the first step, and automatically calculating initially radiometric values and subsequently automatically calculating high-resolution image data of the highly resolved image in a third step for the at least one point or region of interest identified in the second step.

2. The method as claimed in claim 1, wherein the raw images are recorded by a thermal imaging camera or a two-dimensionally recording, infrared-sensitive detector.

3. The method as claimed in claim 1, wherein the edge contrast enhancement of the raw images is carried out by peaking, by Laplace filtering, or unsharp masking.

4. The method as claimed in claim 1, wherein radiometric data of the at least one point or region of interest are calculated automatically by a stored characteristic.

5. The method as claimed in claim 1, further comprising calculating a displacement vector describing an image displacement for each said raw image for the purposes of calculating the highly resolved image from the sequence of raw images.

6. The method as claimed in claim 5, wherein the displacement vector is calculated on the basis of the point or regions of interest.

7. The method as claimed in claim 1, wherein at least 3 or more of the raw images are processed for the automatic calculation of the highly resolved image.

8. The method as claimed in claim 1, wherein a temperature of the at least one point or region of interest is ascertained on the basis of at least one calculated, highly resolved image.

9. The method as claimed in claim 1, wherein at least one of a temperature maximum, a temperature minimum, a specific temperature value, or a temperature range is automatically identified in the highly resolved image.

10. The method as claimed in claim 1, wherein the at least one point or region of interest is identified in the raw image by segmentation or in each case at least one point or region is identified in the individual raw images of the sequence, said at least one point or region corresponding to the at least one point or region of interest of the at least one raw image.

11. The method as claimed in claim 1, wherein the at least one identified point or region is used for calculating the highly resolved image.

12. A thermal image recording apparatus for recording and preparing raw images for producing radiometric images, which have a high resolution in portions, the thermal image recording apparatus comprises a detector configured to record raw images, an image processing device that identifies at least one point or region of interest, a means for calculating radiometric data, and a means for calculating highly resolved image data of the highly resolved image.

13. The thermal image recording apparatus as claimed in claim 12, wherein the image region for which a calculation of the radiometric data is carried out is predeterminable.

14. The thermal image recording apparatus as claimed in claim 12, wherein the point or region of interest, for which the radiometric data is ascertained in an approximation method, is predeterminable or the thermal image recording apparatus comprises a means for converting an image position in a highly resolved image to an image position at the resolution of a raw image.

15. The thermal image recording apparatus as claimed in claim 12, wherein the thermal image recording apparatus is configured to carry out a method comprising recording a sequence of raw images composed of pixels in a nonvisible spectral range and calculating radiometric images from said sequence of raw images, wherein an image with a high resolution at least in one portion is calculated, automatically calculating edge contrast enhancement for at least one of the raw images from the sequence in a first step, identifying at least one point or region of interest in a second step from the at least one raw image modified by the edge contrast enhancement in the first step, and automatically calculating initially radiometric values and subsequently automatically calculating high-resolution image data of the highly resolved image in a third step for the at least one point or region of interest identified in the second step.

16. The method as claimed in claim 1, wherein at least one of a hottest point, a coldest point, a hottest region, a coldest region, or a point or region in a predetermined temperature range is identified as the at least one point or region of interest.

17. The method claimed in claim 1, wherein radiometric data for all points or regions of interest which lie outside of the at least one point or region of interest are ascertained by an approximation method.

18. The method of claim 5, wherein the at least one point or region of interest is identified in the further raw images to be processed on the basis of the displacement vector.

19. The method of claim 1, wherein the at least one highly resolved point or region of interest is displayed in an image, which at least partly has lower resolution.

20. The method claimed in claim 1, wherein at least one of a temperature maximum identified in the highly resolved image, a temperature minimum, a temperature value, or temperature range derived from the highly resolved image is displayed in a radiometric image with the resolution of the raw image.
